(19) United States
(12) Patent Application Publication
(10) Pub. No.: US 2017/0101000 A1
(43) Pub. Date: Apr. 13, 2017

(54) AUXILIARY ELECTRIC DRIVE WITH WHEEL HUB DISCONNECT

(71) Applicant: GM GLOBAL TECHNOLOGY OPERATIONS LLC, Detroit, MI (US)

(72) Inventors: Shawn H. Swales, Canton, MI (US); Goro Tamai, Bloomfield Hills, MI (US)

(73) Assignee: GM GLOBAL TECHNOLOGY OPERATIONS LLC, Detroit, MI (US)

(21) Appl. No.: 14/876,888

(22) Filed: Oct. 7, 2015

(51) Int. Cl. B60K 6/50; B60K 17/00; B60B 37/00

(52) U.S. Cl. CPC B60K 6/50; B60B 37/00; B60K 17/00; Y10S 903/902; B60K 6/48

(57) ABSTRACT

A powertrain includes an axle end assembly rotatable about a wheel axis. A wheel bearing housing rotatably supports an outer axle end of the axle end assembly. A wheel hub is rotatably supported by the wheel bearing housing for rotation about the wheel axis. A hub actuating system is coupled to the wheel bearing housing, and is selectively controllable between an engaged state for rotatably coupling the wheel hub and the outer axle end together, and a disengaged state for de-coupling the wheel hub and the outer axle end. At least one axle bearing interconnects and rotatably supports the outer axle end relative to the actuator housing so that the outer axle end and the wheel hub are axially stacked relative to each other along the wheel axis, and the wheel hub and the outer axle end do not radially overlap each other relative to the wheel axis.

### TECHNICAL FIELD

The disclosure generally relates to a powertrain for a vehicle, and more particularly to an auxiliary electric powertrain.

### BACKGROUND

A powertrain includes the main components of a device that generate power and deliver it to a location. In vehicles, such as automobiles, the powertrain may include but is not limited to a torque producing device such as an internal combustion engine or an electric motor, a geartrain or transmission, a differential, one or more axle shafts, a final drive such as a wheel, and the various elements required to connect the above noted components.

Some vehicles may be equipped with a primary powertrain and an auxiliary powertrain. For example, an automobile may be equipped with a primary powertrain that is used in all circumstances to power the front wheels of a vehicle, and an auxiliary powertrain that is used to selectively power the rear wheels of the vehicle. Such a configuration may be used to provide all wheel drive capabilities to a vehicle that would otherwise only be front wheel drive. Accordingly, the auxiliary powertrain is only engaged to power the rear wheels in certain circumstances, and is otherwise not engaged to power the rear wheels. Because the auxiliary powertrain is connected to the rear wheels, various components of the auxiliary powertrain may be rotated by the wheels when the auxiliary powertrain is not being engaged to power the rear wheels, thereby introducing various energy losses into the system in the form of friction and/or energy required to rotate the mass of the various components.

### SUMMARY

A powertrain is provided. The powertrain includes a torque producing device, and a differential coupled to the torque producing device. An axle is coupled to the differential, and includes an outer axle end rotatable about a wheel axis. A wheel bearing housing rotatably supports the outer axle end of the axle. A wheel hub is rotatably supported by the wheel bearing housing for rotation about the wheel axis. A hub actuating system is coupled to the wheel bearing housing. The hub actuating system is selectively controllable between an engaged state and a disengaged state. When disposed in the engaged state, the hub actuating system rotatably couples the wheel hub and the outer axle end together for co-rotation about the wheel axis. When the hub actuating system is disposed in the disengaged state, the hub actuating system rotatably de-couples the wheel hub and the outer axle end, to allow the wheel hub to rotate relative to the outer axle end.

An auxiliary electric powertrain is also provided. The auxiliary electric powertrain includes an electric motor, a differential coupled to the electric motor, and a gear train interconnecting the electric motor and the differential. A first axle is coupled to the differential, and includes a first outer axle end rotatable about a first wheel axis. A second axle is coupled to the differential, and includes a second outer axle end rotatable about a second wheel axis. A first wheel bearing housing rotatably supports the first outer axle end of the first axle. A second wheel bearing housing rotatably supports the second outer axle end of the second axle. A first wheel hub is rotatably supported by the first wheel bearing housing for rotation about the first wheel axis. A second wheel hub is rotatably supported by the second wheel bearing housing for rotation about the second wheel axis. A first hub actuating system is coupled to the first wheel bearing housing. The first hub actuating system is selectively controllable between an engaged state and a disengaged state. When the first hub actuating system is disposed in the engaged state, the first hub actuating system rotatably couples the first wheel hub and the first outer axle end together for co-rotation about the first wheel axis. When the first hub actuating system is disposed in the disengaged state, the first hub actuating system rotatably de-couples the first wheel hub and the first outer axle end to allow the first wheel hub to rotate relative to the first outer axle end. A second hub actuating system is coupled to the second wheel bearing housing. The second hub actuating system is selectively controllable between an engaged state and a disengaged state. When the second hub actuating system is disposed in the engaged state, the second hub actuating system rotatably couples the second wheel hub and the second outer axle end together for co-rotation about the second wheel axis. When the second hub actuating system is disposed in the disengaged state, the second hub actuating system rotatably de-couples the second wheel hub and the second outer axle end to allow the second wheel hub to rotate relative to the second outer axle end.

An axle end assembly is also provided. The axle end assembly includes a wheel bearing housing, and a wheel hub rotatably supported by the wheel bearing housing for rotation about a wheel axis. At least one wheel bearing interconnects and rotatably supports the wheel hub relative to the wheel bearing housing. The axle assembly further includes an outer axle end, and a hub actuating system. The hub actuating system includes an actuator housing attached to the wheel bearing housing. The actuator housing of the hub actuating system interconnects the wheel bearing housing and the outer axle end, and rotatably supports the outer axle end for rotation about the wheel axis. At least one axle bearing interconnects and rotatably supports the outer axle end relative to the actuator housing of the hub actuating system.

Accordingly, the powertrain may be configured as the auxiliary electric powertrain, and include the axle assembly noted above. The hub actuating system at each wheel hub connected to the powertrain may be used to disconnect the components of the powertrain from the wheel hubs, thereby eliminating energy losses and/or potential damage to the components of the powertrain caused by the wheels of the vehicle rotating the components of the powertrain when the powertrain is not being used to power the wheels. It is advantageous to disconnect the powertrain from the wheel hubs at a location that is as close to the wheel hubs as possible, in order to maximize the number and mass of components that are disconnected from the wheel hubs, and are therefore not rotated by the wheel hubs when the powertrain is not being used to power the wheels.

The above features and advantages and other features and advantages of the present teachings are readily apparent from the following detailed description of the best modes for carrying out the teachings when referencing the accompanying drawings.

### BRIEF DESCRIPTION OF THE DRAWINGS

FIG. 1 is a schematic plan view of a vehicle showing a primary powertrain, and an auxiliary electric powertrain.

FIG. 2 is a schematic cross sectional view of an axle assembly of the auxiliary electric powertrain.

FIG. 3 is a schematic cross sectional view of an alternative embodiment of the auxiliary electric powertrain.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

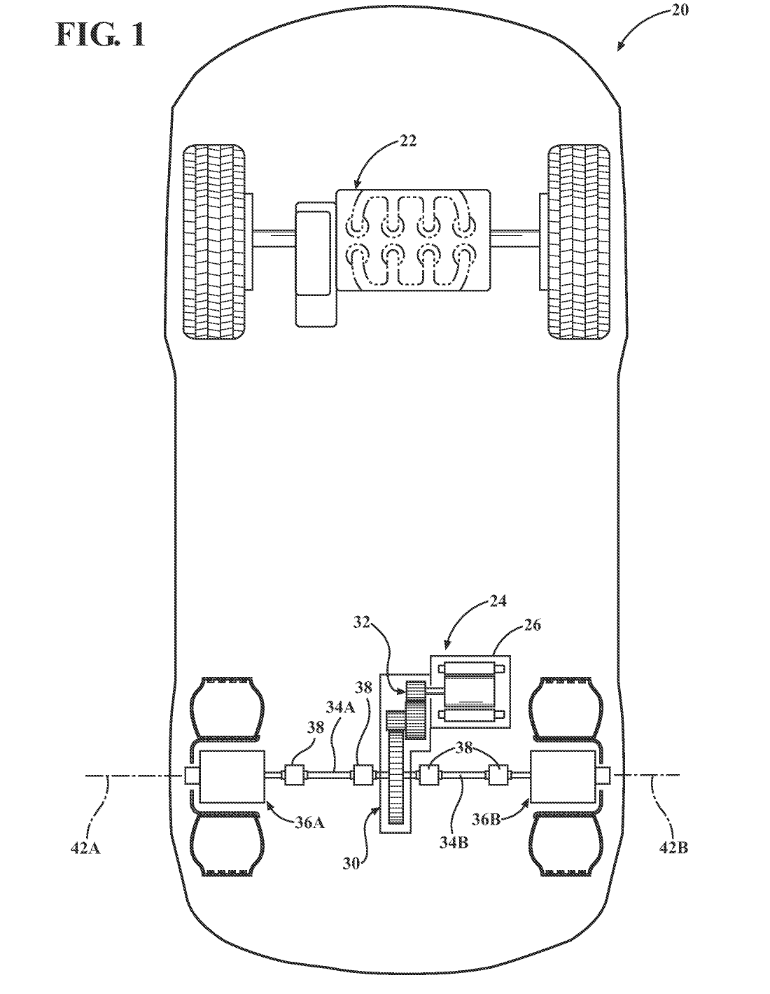

Referring to the Figures, wherein like numerals indicate like parts throughout the several views, a vehicle is generally shown at 20 in FIG. 1. The vehicle 20 includes at least one powertrain. The exemplary embodiment of the vehicle 20 shown in FIG. 1 is configured as an automobile, and includes a primary powertrain 22 and an auxiliary powertrain 24. It should be appreciated that the vehicle 20 may be configured differently than the automobile shown, such as a boat, airplane, train, etc. Furthermore, it should be appreciated that a powertrain according to the teachings of the disclosure may be incorporated into machines or systems other than vehicles 20. Accordingly, the teachings of the disclosure should not be limited to applications similar to the exemplary embodiment of the automobile shown in FIG. 1.

The teachings of the disclosure may be incorporated into either the primary powertrain 22 and/or the auxiliary powertrain 24. As shown and described herein, the relevant portions of the disclosure are incorporated into and described with reference to the auxiliary powertrain 24. Although the exemplary embodiment shows both the primary powertrain 22 and the auxiliary powertrain 24, it should be appreciated that the teachings of the disclosure do not require both the primary powertrain 22 and the auxiliary powertrain 24, and may be incorporated into a machine having only a single powertrain.

As shown in the exemplary embodiment of FIG. 1, the primary powertrain 22 is the primary mover of the vehicle 20, and may be configured in any suitable manner. For example, and as shown in FIG. 1, the primary powertrain 22 may include an internal combustion engine, a transmission, a differential, at least one axle, and wheel ends rotatably supporting and powering front wheels of the vehicle 20. The primary powertrain 22 may include other suitable types and/or configurations of powertrains capable of exclusively providing the power for moving the vehicle 20.

The powertrain in accordance with the teachings of the disclosure is described below with reference to the auxiliary powertrain 24. The auxiliary powertrain 24 includes a torque producing device 26. As shown in FIG. 1, the torque producing device 26 is an electric motor. As such, the auxiliary powertrain 24 may be referred to as an auxiliary electric powertrain. However, it should be appreciated that the torque producing device 26 could include a device other than the electric motor shown, such as an internal combustion engine or other similar device. The torque producing device 26 may include any device that is operable to generate and/or provide torque with rotational output.

A differential 30 is coupled to the torque producing device 26, i.e., the electric motor. The differential 30 may include any typical automotive differential 30 known to those skilled in the art. The differential 30 splits the rotational input from the torque producing device 26 between a first side and a second side, and allows the first side and the second side to rotate at different rotational speeds as is known. As used herein, the adjective “first” refers to the first side of the differential 30 or a driver's side of the vehicle 20, and the adjective “second” refers to the second side of the differential 30, or a passenger's side of the vehicle 20. The terms “first” and “second” are not used to imply a number or quantity, but are rather used to designate a relative position on the vehicle 20. Features of the auxiliary powertrain 24 that are identical on both the first side and the second side are labeled with the suffix “A” to represent the first side, or the suffix “B” to represent the second side. A gear train 32 (transmission) may be used to interconnect the torque producing device 26, i.e., the electric motor, and the differential 30. The gear train 32 may be used to change the rotational speed and torque output from the torque producing device 26 as is known in the art.

Referring to FIG. 1, a first axle 34A and a second axle 34B are coupled to the differential 30. Both the first axle 34A and the second axle 34B may be referred to as a halfshaft. The first axle 34A includes a first axle end assembly 36A, and the second axle 34B includes a second axle end assembly 36B. The first axle 34A connects the first axle end assembly 36A and the differential 30, and the second axle 34B connects the second axle end assembly 36B and the differential 30. The first axle 34A and the second axle 34B may each include one or more angular joints 38 as is known in the art.

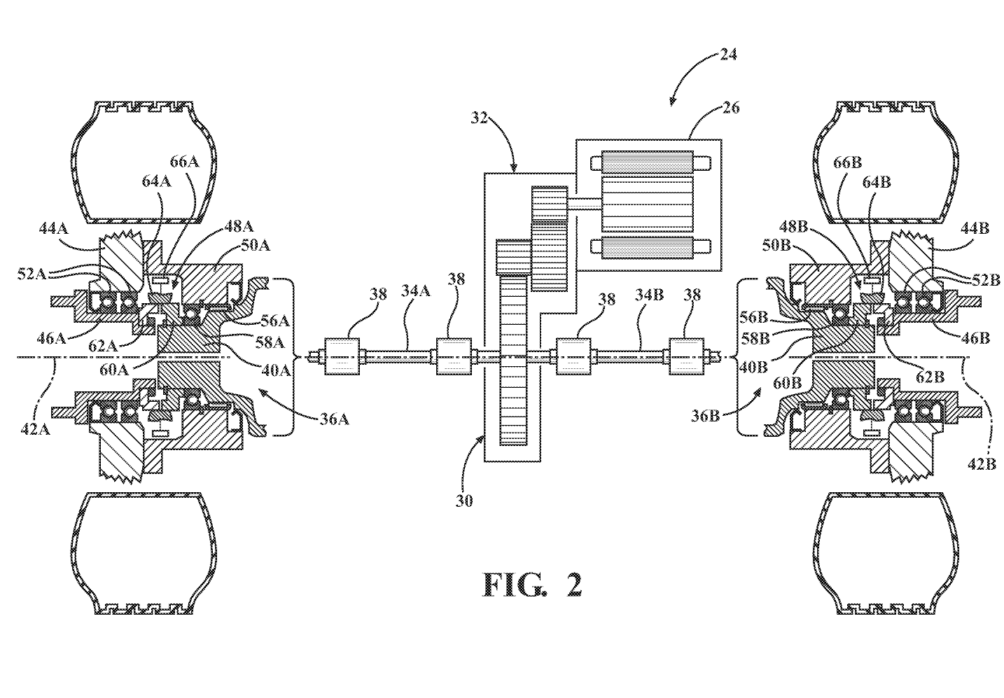

The first axle end assembly 36A and the second axle end assembly 36B are identical, and mirror images of each other. Referring to FIG. 2, the first axle end assembly 36A includes a first outer axle end 40A. The first outer axle end 40A is rotatable about a first wheel axis 42A. A first wheel bearing housing 44A rotatably supports the first outer axle end 40A of the first axle 34A. The first wheel bearing housing 44A is attached to a rigid structure, such as a frame or suspension system of the vehicle 20. The first wheel bearing housing 44A may be embodied as a structural component of the vehicle 20, or the suspension system, such as but not limited to a steering knuckle. A first wheel hub 46A is rotatably supported by the first wheel bearing housing 44A for rotation about the first wheel axis 42A. The first wheel hub 46A rotatably supports a wheel as is known in the art.

The first axle end assembly 36A includes a first hub actuating system 48A. The first hub actuating system 48A is coupled to the first wheel bearing housing 44A, and is selectively controllable to move between an engaged state and a disengaged state. When the first hub actuating system 48A is disposed in the engaged state, the first hub actuating system 48A rotatably couples the first wheel hub 46A and the first outer axle end 40A for co-rotation together, about the first wheel axis 42A. When the first hub actuating system 48A is disposed in the disengaged state, the first hub actuating system 48A rotatably de-couples the first wheel hub 46A and the first outer axle end 40A to allow the first wheel hub 46A to rotate relative to the first outer axle end 40A, thereby disconnecting the first wheel hub 46A from the rest of the auxiliary powertrain 24.

The first hub actuating system 48A includes a first actuator housing 50A fixedly attached to the first wheel bearing housing 44A. The first actuator housing 50A may be attached to the first wheel bearing housing 44A in any suitable manner, such as with a plurality of fasteners, such as bolts, a welded connection, or alternatively, the first actuator housing 50A and the first wheel bearing housing 44A may be integrally formed together as a single manufacture.

At least one first wheel bearing interconnects and rotatably supports the first wheel hub 46A relative to the first wheel bearing housing 44A. As shown, the at least one first wheel bearing includes two wheel ball bearings 52A arranged adjacent each other along the first wheel axis 42A. The first axle end assembly 36A further includes at least one first axle bearing interconnecting and rotatably supporting the first outer axle end 40A relative to the first actuator housing 50A. As shown, the at least one first axle bearing includes an axle needle bearing 56A and an axle ball bearing 58A, arranged adjacent to each other along the first wheel axis 42A.

The first outer axle end 40A and the first wheel hub 46A are axially stacked relative to each other along the first wheel axis 42A, such that the first wheel hub 46A and the first outer axle end 40A do not radially overlap each other relative to the first wheel axis 42A. Accordingly, the first outer axle end 40A and the first wheel hub 46A are arranged end-to-end along the first wheel axis 42A, and do not overlap each other along the first wheel axis 42A.

The first hub actuating system 48A includes a first axle end dog clutch member 60A attached to the first outer axle end 40A, a first wheel end dog clutch member 62A attached to the first wheel hub 46A, and a first sliding dog clutch member 64A. The first sliding dog clutch member 64A is axially moveable along the first wheel axis 42A to change the first hub actuating system 48A between the engaged state and the disengaged state. The first sliding dog clutch member 64A is engaged with only one of the first axle end dog clutch member 60A and the first wheel end dog clutch member 62A when the first hub actuating system 48A is disposed in the disengaged state. The first sliding dog clutch member 64A is simultaneously engaged with both the first axle end dog clutch member 60A and the first wheel end dog clutch member 62A when the first hub actuating system 48A is disposed in the engaged state.

The first actuator housing 50A supports a first actuator 66A, which moves the first sliding dog clutch member 64A along the first wheel axis 42A, to change the operating state of the first hub actuating system 48A between the engaged state and the disengaged state. The first actuator 66A may include any suitable style and/or configuration of actuator, such as a pneumatic actuator, a hydraulic actuator, an electric actuator, or some other device capable of moving the first sliding dog clutch member 64A.

Referring to FIG. 2, the second axle end assembly 36B includes a second outer axle end 40B. The second outer axle end 40B is rotatable about a second wheel axis 42B. A second wheel bearing housing 44B rotatably supports the second outer axle end 40B of the second axle 34B. The second wheel bearing housing 44B is attached to a rigid structure, such as a frame or suspension system of the vehicle 20. The second wheel bearing housing 44B may be embodied as a structural component of the vehicle 20, or the suspension system, such as but not limited to a steering knuckle. A second wheel hub 46B is rotatably supported by the second wheel bearing housing 44B for rotation about the second wheel axis 42B. The second wheel hub 46B rotatably supports a wheel as is known in the art.

The second axle end assembly 36B includes a second hub actuating system 48B. The second hub actuating system 48B is coupled to the second wheel bearing housing 44B, and is selectively controllable to move between an engaged state and a disengaged state. When the second hub actuating system 48B is disposed in the engaged state, the second hub actuating system 48B rotatably couples the second wheel hub 46B and the second outer axle end 40B for co-rotation together, about the second wheel axis 42B. When the second hub actuating system 48B is disposed in the disengaged state, the second hub actuating system 48B rotatably de-couples the second wheel hub 46B and the second outer axle end 40B to allow the second wheel hub 46B to rotate relative to the second outer axle end 40B, thereby disconnecting the second wheel hub 46B from the rest of the auxiliary powertrain 24.

The second hub actuating system 48B includes a second actuator housing 50B fixedly attached to the second wheel bearing housing 44B. The second actuator housing 50B may be attached to the second wheel bearing housing 44B in any suitable manner, such as with a plurality of fasteners, such as bolts, a welded connection, or alternatively, the second actuator housing 50B and the second wheel bearing housing 44B may be integrally formed together as a single manufacture.

At least one second wheel bearing interconnects and rotatably supports the second wheel hub 46B relative to the second wheel bearing housing 44B. As shown, the at least one second wheel bearing includes two wheel ball bearings 52B arranged adjacent to each other along the second wheel axis 42B. The second axle end assembly 36B further includes at least one second axle bearing interconnecting and rotatably supporting the second outer axle end 40B relative to the second actuator housing 50B. As shown, the at least one second axle bearing includes an axle needle bearing 56B and an axle ball bearing 58B, arranged adjacent each other along the second wheel axis 42 B.

The second outer axle end 40B and the second wheel hub 46B are axially stacked relative to each other along the second wheel axis 42B, such that the second wheel hub 46B and the second outer axle end 40B do not radially overlap each other relative to the second wheel axis 42B. Accordingly, the second outer axle end 40B and the second wheel hub 46B are arranged end-to-end along the second wheel axis 42B, and do not overlap each other along the second wheel axis 42B.

The second hub actuating system 48B includes a second axle end dog clutch member 60B attached to the second outer axle end 40B, a second wheel end dog clutch member 62B attached to the second wheel hub 46B, and a second sliding dog clutch member 64B. The second sliding dog clutch member 64B is axially moveable along the second wheel axis 42B to change the second hub actuating system 48B between the engaged state and the disengaged state. The second sliding dog clutch member 64B is engaged with only one of the second axle end dog clutch member 60B and the second wheel end dog clutch member 62B when the second hub actuating system 48B is disposed in the disengaged state. The second sliding dog clutch member 64B is simultaneously engaged with both the second axle end dog clutch member 60B and the second wheel end dog clutch member 62B when the second hub actuating system 48B is disposed in the engaged state.

The second actuator housing 50B supports a second actuator 66B, which moves the second sliding dog clutch member 64B along the second wheel axis 42B, to change the operating state of the second hub actuating system 48B between the engaged state and the disengaged state. The second actuator 66B may include any suitable style and/or configuration of an actuator, such as a pneumatic actuator, a hydraulic actuator, an electric actuator, or some other device capable of moving the second sliding dog clutch member 64B.

The configuration of the first axle end assembly 36A and the second axle end assembly 36B described above and shown in FIG. 2, rotatably disconnects the outer axle ends from their respective wheel hubs when their respective hub actuating system is disengaged, thereby eliminating losses associated with rotation of their respective axle bearings. Accordingly, when the hub actuating system 48 is disposed in the engaged state, both the axle bearings 56, 58 and the wheel bearings 52 spin, and when the hub actuating system 48 is disposed in the disengaged state, the wheel bearings 52 spin and the axle bearings 56, 58 do not spin. Such a configuration minimizes losses, and is particularly suited for the auxiliary powertrain 24, in which the wheel hubs are only occasionally engaged to power the vehicle 20.

The first hub actuating system 48A and the second hub actuating system 48B are independently operable relative to each other. Accordingly, the first hub actuating system 48A may be controlled between its respective engaged state and disengaged state when the second hub actuating system 48B is disposed in either of its respective engaged state and disengaged state. Similarly, the second hub actuating system 48B may be controlled between its respective engaged state and disengaged state when the first hub actuating system 48A is disposed in either of its respective engaged state and disengaged state. The ability to control the first hub actuating system 48A and the second hub actuating system 48B independently of each other allows for the control of the auxiliary powertrain 24 in the event that one of the first hub actuating system 48A or the second hub actuating system 48B fault to their respective engaged state. If such a fault occurs, the functioning hub actuating system may be controlled to its respective disengaged state to allow the differential 30 to freely spin, while the torque producing device 26 is disengaged, thereby protecting the torque producing device 26 from being over-spun. Alternatively, the torque producing device 26 may be engaged to provide torque to the differential 30, thereby partially slowing the rotational speed of the faulty wheel hub.

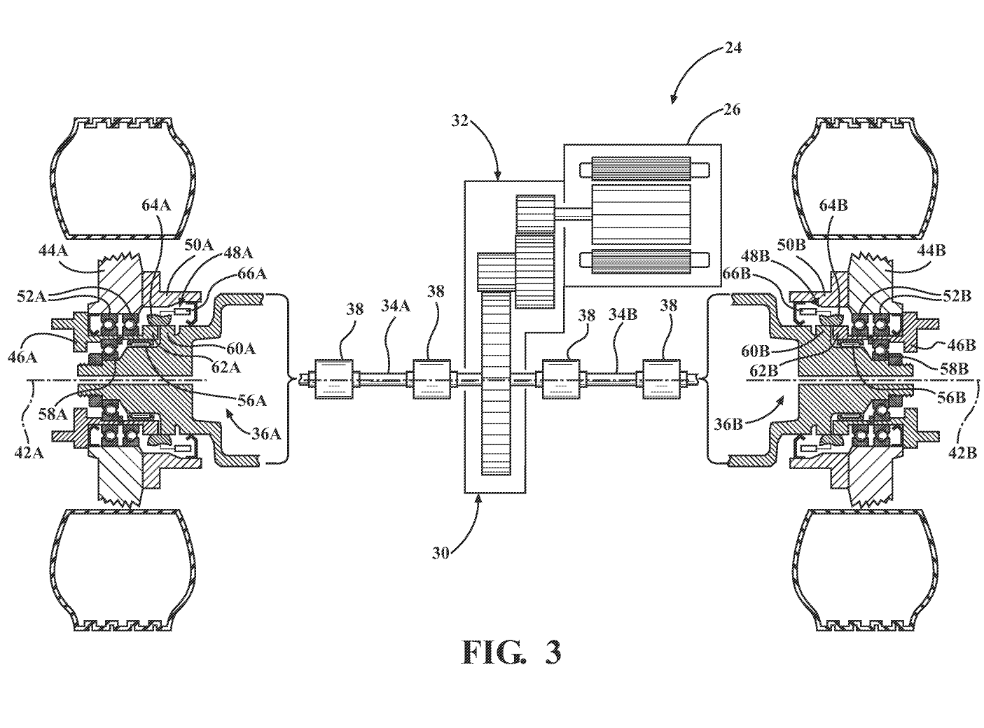

Referring to FIG. 3, an alternative embodiment of the first axle end assembly 36A and the second axle end assembly 36B are shown. Similar features of the first axle end assembly 36A and the second axle end assembly 36B shown in FIG. 3 are identified with the same reference numerals used to identify the similar features of the first axle end assembly 36A and the second axle end assembly 36B shown in FIG. 2.

The primary difference between the alternative embodiment of the axle end assemblies shown in FIG. 2 and the axle end assemblies shown in FIG. 3 is the relative location of the wheel hub 46 and the outer axle end 40. Referring to FIG. 3, the first axle end assembly 36A includes the first axle bearings 56A, 58A interconnecting and rotatably supporting the first outer axle end 40A relative to the first wheel hub 46A. The first outer axle end 40A and the first wheel hub 46A are radially stacked relative to each other about the first wheel axis 42A, such that the first wheel hub 46A and the first outer axle end 40A radially overlap each other relative to the first wheel axis 42A.

The second axle end assembly 36B is similarly configured. Referring to FIG. 3, the second axle end assembly 36B includes the second axle bearings 56B, 58B interconnecting and rotatably supporting the second outer axle end 40B relative to the second wheel hub 46B. The second outer axle end 40B and the second wheel hub 46B are radially stacked relative to each other about the second wheel axis 42B, such that the second wheel hub 46B and the second outer axle end 40B radially overlap each other relative to the second wheel axis 42B.

The configuration of the first axle end assembly 36A and the second axle end assembly 36B described above and shown in FIG. 3, rotatably connects the outer axle ends 40 and their respective wheel hubs 46 when their respective hub actuating systems 48 are disengaged, and prevents relative rotation between the outer axle ends 40 and their respective wheel hubs 46 when their respective hub actuating systems 48 are engaged. Accordingly, when the hub actuating system 48 is disposed in the engaged state, the wheel bearings 52 spin and the axle bearings 56, 58 do not spin, and when the hub actuating system 48 is disposed in the disengaged state, both the wheel bearings 52 and the axle bearings 56, 58 spin. Such a configuration is particularly suited for a powertrain in which the wheel hubs 46 are regularly or often engaged to power the vehicle 20.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A powertrain comprising:
a torque producing device;
a differential coupled to the torque producing device;
an axle coupled to the differential, and including an outer axle end rotatable about a wheel axis;
a wheel bearing housing rotatably supporting the outer axle end of the axle;
a wheel hub rotatably supported by the wheel bearing housing for rotation about the wheel axis; and
a hub actuating system coupled to the wheel bearing housing and selectively controllable between an engaged state rotatably coupling the wheel hub and the outer axle end for co-rotation together about the wheel axis, and a disengaged state rotatably de-coupling the wheel hub and the outer axle end to allow the wheel hub to rotate relative to the outer axle end.

2. The powertrain set forth in claim 1 wherein the torque producing device is an electric motor.

3. The powertrain set forth in claim 2 further comprising a gear train interconnecting the electric motor and the differential.

4. The powertrain set forth in claim 1 wherein the hub actuating system includes an axle end dog clutch member attached to the outer axle end, and a wheel end dog clutch member attached to the wheel hub.

5. The powertrain set forth in claim 4 wherein the hub actuating system includes a sliding dog clutch member axially moveable along the wheel axis to change the hub actuating system between the engaged state and the disengaged state, wherein the sliding dog clutch member is engaged with only one of the axle end dog clutch member and the wheel end dog clutch member when the hub actuating system is disposed in the disengaged state, and wherein the sliding dog clutch member is simultaneously engaged with both the axle end dog clutch member and the wheel end dog clutch member when the hub actuating system is disposed in the engaged state.

6. The powertrain set forth in claim 5 wherein the hub actuating system includes an actuator attached to the wheel bearing housing, and operable to move the sliding dog clutch member axially along the wheel axis.

7. The powertrain set forth in claim 6 further compromising at least one wheel bearing interconnecting and rotatably supporting the wheel hub relative to the wheel bearing housing.

8. The powertrain set forth in claim 7 further comprising at least one axle bearing interconnecting and rotatably supporting the outer axle end relative to the actuator of the hub actuating system.

9. The powertrain set forth in claim 8 wherein the at least one axle bearing includes a needle bearing unit and a ball bearing unit.

10. The powertrain set forth in claim 8 wherein the outer axle end and the wheel hub are axially stacked relative to each other along the wheel axis, such that the wheel hub and the outer axle end do not radially overlap each other relative to the wheel axis, wherein both the at least one axle bearing and the at least one wheel bearing spin when the hub actuating system is disposed in the engaged state, and wherein the at least one wheel bearing spins and the at least one axle bearing does not spin when the hub actuating system is disposed in the disengaged state.

11. The powertrain set forth in claim 7 further comprising at least one axle bearing interconnecting and rotatably supporting the outer axle end relative to the wheel hub.

12. The powertrain set forth in claim 11 wherein the outer axle end and the wheel hub are radially stacked relative to each other about the wheel axis, such that the wheel hub and the outer axle end radially overlap each other relative to the wheel axis, wherein the at least one wheel bearing spins and the at least one axle bearing does not spin when the hub actuating system is disposed in the engaged state, and wherein both the at least one wheel bearing and the at least one axle bearing spin when the hub actuating system is disposed in the disengaged state.

13. An auxiliary electric powertrain comprising:
an electric motor;
a differential coupled to the electric motor;
a gear train interconnecting the electric motor and the differential;
a first axle coupled to the differential, and including a first outer axle end rotatable about a first wheel axis;
a second axle coupled to the differential, and including a second outer axle end rotatable about a second wheel axis;
a first wheel bearing housing rotatably supporting the first outer axle end of the first axle;
a second wheel bearing housing rotatably supporting the second outer axle end of the second axle;
a first wheel hub rotatably supported by the first wheel bearing housing for rotation about the first wheel axis;
a second wheel hub rotatably supported by the second wheel bearing housing for rotation about the second wheel axis;
a first hub actuating system coupled to the first wheel bearing housing and selectively controllable between an engaged state rotatably coupling the first wheel hub and the first outer axle end for co-rotation together about the first wheel axis, and a disengaged state rotatably de-coupling the first wheel hub and the first outer axle end to allow the first wheel hub to rotate relative to the first outer axle end; and
a second hub actuating system coupled to the second wheel bearing housing and selectively controllable between an engaged state rotatably coupling the second wheel hub and the second outer axle end for co-rotation together about the second wheel axis, and a disengaged state rotatably de-coupling the second wheel hub and the second outer axle end to allow the second wheel hub to rotate relative to the second outer axle end.

14. The auxiliary electric powertrain set forth in claim 13 wherein the first hub actuating system and the second hub actuating system are independently operable relative to each other, such that the first hub actuating system may be controlled between its respective engaged state and disengaged state when the second hub actuating system is disposed in either of its respective engaged state and disengaged state, and the second hub actuating system may be controlled between its respective engaged state and disengaged state when the first hub actuating system is disposed in either of its respective engaged state and disengaged state.

15. The auxiliary electric powertrain set forth in claim 13 wherein the first hub actuating system includes a first actuator having a first actuator housing attached to the first wheel bearing housing, and the second hub actuating system includes a second actuator having a second actuator housing attached to the second wheel bearing housing.

16. The auxiliary electric powertrain set forth in claim 15 further compromising:
at least one first wheel bearing interconnecting and rotatably supporting the first wheel hub relative to the first wheel bearing housing;
at least one second wheel bearing interconnecting and rotatably supporting the second wheel hub relative to the second wheel bearing housing;
at least one first axle bearing interconnecting and rotatably supporting the first outer axle end relative to the first actuator housing; and
at least one second axle bearing interconnecting and rotatably supporting the second outer axle end relative to the second actuator housing.

17. The auxiliary electric powertrain set forth in claim 16 wherein the first outer axle end and the first wheel hub are axially stacked relative to each other along the first wheel axis, such that the first wheel hub and the first outer axle end do not radially overlap each other relative to the first wheel axis, and wherein the second outer axle end and the second wheel hub are axially stacked relative to each other along the second wheel axis, such that the second wheel hub and the second outer axle end do not radially overlap each other relative to the second wheel axis.

18. An axle end assembly comprising:
a wheel bearing housing;
a wheel hub rotatably supported by the wheel bearing housing for rotation about a wheel axis;
at least one wheel bearing interconnecting and rotatably supporting the wheel hub relative to the wheel bearing housing;
an outer axle end;
a hub actuating system having an actuator housing attached to the wheel bearing housing, wherein the actuator housing of the hub actuating system interconnects the wheel bearing housing and the outer axle end, and rotatably supports the outer axle end for rotation about the wheel axis; and
at least one axle bearing interconnecting and rotatably supporting the outer axle end relative to the actuator housing of the hub actuating system.

19. The axle assembly set forth in claim 18 wherein the outer axle end and the wheel hub are axially stacked relative to each other along the wheel axis, such that the wheel hub and the outer axle end do not radially overlap each other relative to the wheel axis.

20. The axle assembly set forth in claim 19 wherein the hub actuating system includes:
an axle end dog clutch member attached to the outer axle end;
a wheel end dog clutch member attached to the wheel hub; and
a sliding dog clutch member axially moveable along the wheel axis to change the hub actuating system between the engaged state and the disengaged state, wherein the sliding dog clutch member is engaged with only one of the axle end dog clutch member and the wheel end dog clutch member when the hub actuating system is disposed in the disengaged state, and wherein the sliding dog clutch member is simultaneously engaged with both the axle end dog clutch member and the wheel end dog clutch member when the hub actuating system is disposed in the engaged state.
